(19) United States
(12) Patent Application Publication
(10) Pub. No.: US 2017/0314980 A1
(43) Pub. Date: Nov. 2, 2017

(54) OPEN DYNAMIC FLUX CHAMBER

(71) Applicants: POLITECNICO DI MILANO, Milano (IT); THEAREN S.R.L., Torino (TO) (IT)

(72) Inventors: Sabrina Francesca Gabriella Saponaro, Cernusco Sul Naviglio (MI) (IT); Elena Sezenna, Milano (MI) (IT); Alessandro Careghini, Varese (VA) (IT); Andrea Filippo Mastorgio, Gallarate (VA) (IT); Luca Spinelli, San Mauro Torinese (TO) (IT)

(73) Assignees: POLITECNICO DI MILANO, Milano (IT); THEAREN S.R.L., Torino (IT)

(21) Appl. No.: 15/522,796

(22) PCT Filed: Oct. 22, 2015
(86) PCT No.: PCT/IB2015/058147

§ 371 Date: Apr. 28, 2017

(30) Foreign Application Priority Data
Oct. 28, 2014 (IT) BG2014A000046

(51) Int. Cl. G01F 15/04; G01F 15/14

(52) U.S. Cl. CPC G01F 15/04; G01F 15/14

(57) ABSTRACT

An open dynamic flux chamber (10) comprising: a cylindrical box-like body having a bottom opening designed to be rested on an emitting surface; an inlet (15) for a vector gas, positioned on said box-like body; a hole (16) for taking measurements, positioned on said box-like body; at least one vent hole (17) positioned on said box like body to place the mixture of gas present in said box like body in contact with the outside environment; characterized in that said flux chamber (10) has an flat upper base (1) and comprises a tubular shaped windbreak (40) positioned above said upper base (11) to protect said at least one vent hole (17) and having a length greater than 30 cm and a width greater than 5 cm.

The present invention relates to an open dynamic flux chamber and a method for measuring emissions of fumes emanating from a surface, by means of an open dynamic flux chamber.

A method for directly measuring the flux of contaminants originating underground makes use of flux chambers. The flux chamber is an instrument designed to estimate the flux of gases/fumes (mass per surface unit per unit time) emitted by sources such as tips, soil (surface and deep) and aquifers, excluding external influences, such as ambient air background concentrations (linked to vehicle pollution, production plants, etc.) for example, from the assessment.

It consists of an upturned container, placed on a surface, through which the flux of contaminants to be estimated transits.

In dynamic flux chambers (DFC) the air in the chamber is mixed with an external auxiliary fluid, avoiding the accumulation of contaminants in the chamber. In this way, the emissive flux from the ground is not disturbed and so the environmental emission conditions are reproduced. The need in dynamic flux chambers for designing a vent due to the input vector flux is evident. The chambers therefore need an opening to allow excess gas inside the chamber to escape. In the majority of cases, the sizing of the aperture is made in such a way that the pressure inside the chamber is slightly higher (fractions of a Pascal) than the outside pressure (negative or excessively positive pressures alter the natural flux of the emitting surface).

However, during field use, the weak overpressure condition can change, with possible distortion of measurements. In particular, the presence of wind is capable of at least temporarily overcoming the overpressure inside the chamber and cause vortexes with the intrusion of ambient air at the vent point.

Even the slight overpressure caused by the input vector flux (nitrogen or otherwise) is not sufficient to overcome the action of the wind for the entire measurement period, thus affecting the result.

The object of the present invention is to provide a flux chamber that maintains constantly a slight overpressure inside the chamber with respect to the external ambient pressure.

Another object is to provide a flux chamber that is not affected by the presence of wind.

A further object is to provide a chemically inert flux chamber.

Another object is to provide a flux chamber that enables better internal mixing of the gases.

In accordance with the present invention, these and other objects are achieved with an open dynamic flux chamber comprising: a cylindrical box-like body having a bottom opening designed to be rested on an emitting surface; an inlet for a vector gas, positioned on said box-like body; a hole for taking measurements, positioned on said box-like body; and at least one vent hole positioned on said box-like body to place the mixture of gas present in said box-like body in contact with the outside environment; characterized in that said flux chamber has a flat upper base and comprises a tubular shaped windbreak positioned above said upper base to protect said at least one vent hole and having a length greater than 30 cm and a width greater than 5 cm.

These objects are also achieved by a method for measuring emissions of fumes emanating from a surface, by means of an open dynamic flux chamber.

Further characteristics of the invention are described in the dependent claims.

This solution has several advantages with respect to solutions of the known art.

Due to the windbreak, measurements are not altered by the presence or otherwise of wind.

The use of a spiral distributor enables optimal and uniform distribution of the vector gas inside the chamber.

Furthermore, due to the preferable use of connectors on the vent holes, the performance of the chamber improves, further reducing the risk of air intruding from the surrounding environment.

By using materials such as polytetrafluoroethylene and steel, a totally chemically inert chamber is obtained.

The characteristics and advantages of the present invention are evident from the following detailed description of a practical embodiment, shown by way of non-limitative example in the accompanying drawings, in which:

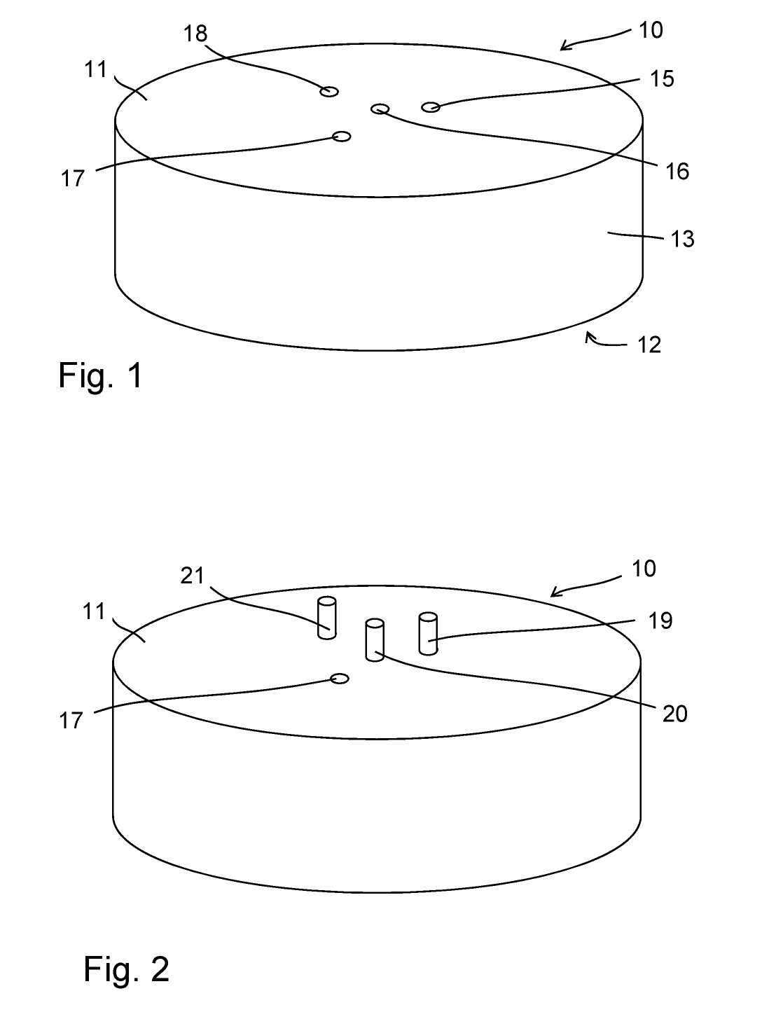

FIG. 1 shows a flux chamber, without windbreak, in accordance with the present invention;

FIG. 2 shows an upper portion of a flux chamber, without windbreak, in accordance with the present invention;

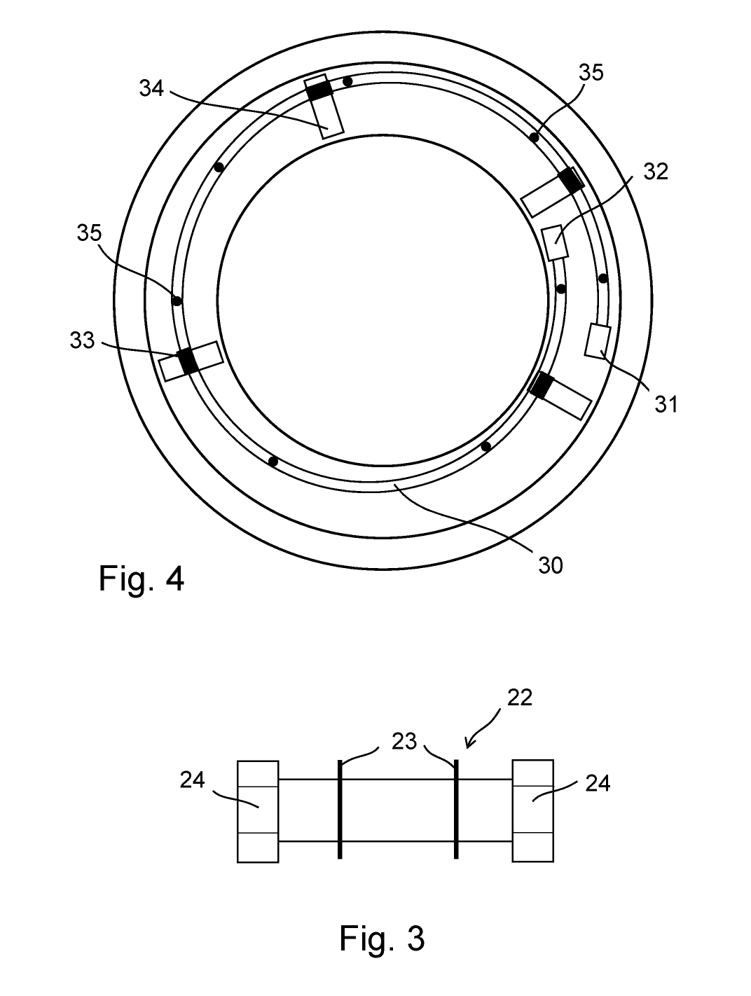

FIG. 3 shows a connector for the vent holes of a flux chamber, in accordance with the present invention;

FIG. 4 shows the inside of a flux chamber, in accordance with the present invention; and

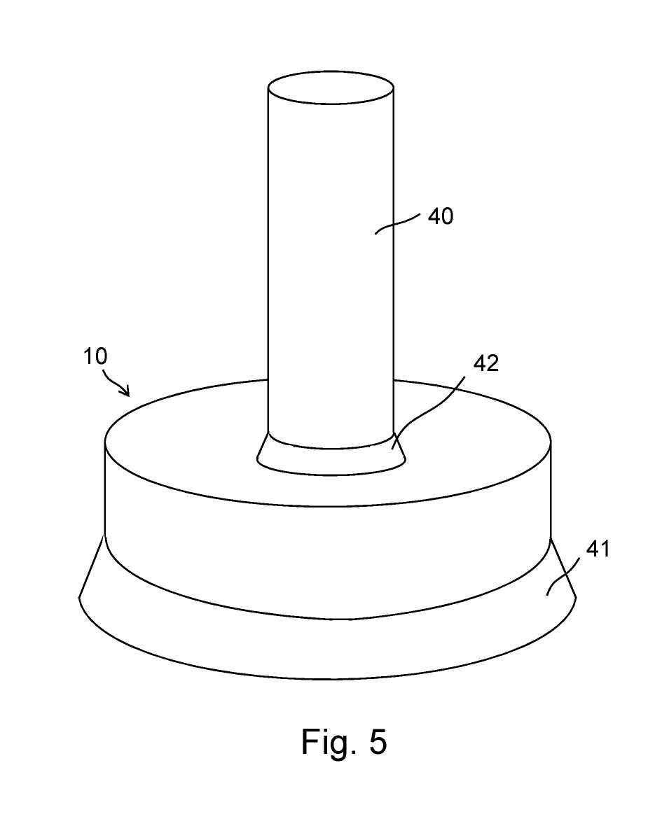

FIG. 5 shows a flux chamber, with a windbreak, in accordance with the present invention.

Referring to the accompanying figures, an open dynamic flux chamber 10, in accordance with the present invention, is made by means of a cylindrical box-like body, with the upper base 11 flat and not domed like flux chambers of the known art. The lower base 12 of cylindrical box-like body is open.

The upper base 11 is preferably detachable from the side walls 13 of the chamber 10 and can be tightly closed, like a lid. Without the upper base 11 it is possible to work freely inside the chamber 10; when operations are completed, the chamber 10 is closed. In particular, the upper base 11 has a smaller diameter at the bottom that wedges with a corresponding increase in the inner diameter of the upper side wall chamber 10, thereby achieving sealed closure.

The chamber 10 was made entirely of polytetrafluoroethylene (PTFE), so as to make it chemically inert. Other inert materials can be used.

By being opaque, the use of PTFE significantly reduces possible greenhouse effects being created inside chamber 10, and so reduces possible measurement distortion, as can happen with a transparent lid.

In the embodiment shown in the figures, the chamber 10 has an internal radius of 24 cm, a thickness of 3,4 cm and an internal height of 20 cm.

Some holes are present on the upper base 11, there being four in the embodiment shown herein (but there could be three or even more than four). The diameter of the holes is 1,6 cm.

A first inlet hole 15 is connected to an external tube (not shown) for admitting the vector fluid into the chamber.

A second outlet hole 16 is provided for inserting a sampling rod (not shown) and taking measurements.

A third hole 17 called “vent” is used to vent excess vector fluid.

A fourth hole 18 also called “vent” can be used both for venting excess vector fluid and for inserting various types of measurement probes inside the chamber, such as ones for temperature, humidity, pressure, percentage of oxygen and more.

Usually, holes 15, 16 and 18 are provided with connectors, respectively 19, 20 and 21, for the quick coupling of the vector gas supply system, for the sampling rod and for any probes for other measurements.

In the embodiment described herein, hole 16 is positioned at the centre of the upper base 11 and holes 15, 17 and 18 are positioned around hole 16 at a distance of 6 cm. The holes 15-18 are thus enclosed in a circle having a diameter of 8,4 cm.

In a particularly advantageous manner, in accordance with the present invention, the vent(s) (17, 18) used for venting excess vector fluid are preferably provided with a sealed connector 22 that comprises an internally bored tubular element, including washers 23 designed to make contact above and below with the upper base 11, and lockable via nuts 24. The length of connector 22 outside surface 11 is between 2 and 10 cm, and is preferably 5 cm.

The sealed connector 22 enables creating a more complex and “protected” surface with respect to that of simple apertures.

Injection of the vector fluid into the chamber 10 takes place through connector 19 and a spiral distribution system is provided inside the chamber 10.

The spiral distribution system is constitute by a tube in polytetrafluoroethylene, 180 cm long, with an internal diameter of 4 mm, having a connector 31 at one end for connection to connector 19 (on the side inside the chamber 10) and is closed at the other end 32.

The tube 30 is positioned in a spiral close to the internal side wall of the chamber 10, to which it is secured by steel clips 33, adjustable in inclination and fastened to bars 34 fixed to the chamber 10.

The tube 30 runs from the top of the chamber 10 and follows the internal wall to reach the bottom thereof.

Eight holes 35, with a diameter of 2 mm and spaced 20 cm apart from each other, are made in the tube 30.

The vector fluid is blown through the holes 35 towards the centre of the chamber 10 in a direction more or less parallel to the plane on which the chamber 10 rests.

The use of a spiral distribution system enables having a more uniform concentration of the mixture of vector gas and emitted pollutant inside the chamber 10. This system, together with the flat upper surface 11, ensures that there will be substantially the same gas concentration in all volume points.

In accordance with one embodiment of the present invention, to avoid measurements being affected by the presence of wind, the chamber 10 is provided with a windbreak 40, which has a straight, tubular cylindrical shape, for aerodynamic motives and or being effective independently of the direction of the wind and its variations during the measurement.

The windbreak 40 is placed and fixed above the chamber 10, on the base 11.

The windbreak 40 had an internal diameter of 18 cm, sufficient to include the vent holes and the other holes present in the upper base 11, which are contained within a circle having a diameter of 8,4 cm.

If the height of the windbreak is low, it is not effective as the intrusion problem due to turbulent motion inside the cylinder remain.

It has been found that windbreaks 40 with heights up to 20 cm are inadequate, while good results are achieved with heights above 30 cm, and even better results with heights equal to or greater than 35 cm. In the embodiment of the present invention, the height is 35 cm.

Reducing the diameter of the windbreak 40 to only protect the vent hole could be considered, but at the same time, it should not have a very small diameter because this could increase the gas discharge resistance and to keep it constant it would be necessary to reduce the height, but reducing the height could make the effects of the wind felt. The possible dimensions of the windbreak 40 are therefore a diameter equal to or greater than 5 cm, and a height greater than 30 cm.

The windbreak 40 could also not be straight and have a different shape to increase protection of the vent holes.

The seal between the windbreak 40 and the chamber is created, in the embodiment, by fine, damp, compacted sand placed in the angle formed between the windbreak 40 and the chamber 10. Other solutions can be provided, such as providing, for example, a circular recess in the surface 11 of the chamber 10 so as to be able to insert the bottom edge of the windbreak 40.

From what has been described, the operation of the invention is evident for a person skilled in the field and, in particular, as follows.

After the chamber has been placed on the emitting surface, the contact surface is sealed using fine, damp, compacted sand 41 on the external side wall 12 of the chamber. This procedure has the two-fold purpose of avoiding air entering from the outside and uncontrolled external leakage from the flux chamber of pollutants emitted by the emitting surface. Other sealing systems are possible, such as mixtures of water and bentonite or kaolinite for example.

The lid (surface 11) is closed after having connected connector 31 of the tube 30 to connector 19 (on the side inside the chamber 10), the vector gas piping to connector 19 (outside the chamber) and the sampling/measurement instrument to connector 20.

The windbreak 40 is positioned on surface 11, incorporating all the holes present, and the contact angle is sealed using fine, damp, compacted sand 42.

As already mentioned, the vent holes are preferably provided with a sealed connector 22 to further reduce the effect of wind.

The vector gas, for example nitrogen of adequate purity, is injected with a flow rate of between 3,5 and 5,5 1/min. A flow of 4,5 1/min causes overpressure in the chamber of 1,25 Pa with respect to the outside environment.

The sampling/measurement instrument applied to connector 20, and possibly other measurement instruments applied to connector 22, enable measuring emission and recording test conditions according to known procedures.

The above chamber has been developed through various types of experimental testing aimed at checking: complete mixing in the chamber, determination of the discharge time and checking the absence of air intrusion in different operating conditions. During the test, the environmental conditions (temperature, pressure, wind and humidity) and those inside the chamber (temperature, pressure, humidity and air speed in the vents) were monitored over time.

In the checks for the absence of intrusion, keeping the chamber in conditions of slight overpressure was monitored over time, both in typical environmental conditions and with artificially created, high ground wind speed. Initially, the tests were performed by only changing the flow rate of the vector gas, giving not totally satisfactory results; subsequent tests therefore investigated the chamber in the configuration with windbreak and connected vents.

In artificial wind conditions, the need for equipping the chamber with a windbreak for maintaining an adequate pressure difference for the entire duration of sampling was also checked.

The chamber in the final configuration with the windbreak was checked over the following range of conditions. Ground wind speed (0,5 m) 0-2,1 m/s; input flow rate of vector fluid Q equal to 3,5-5,5 1/min.

During tests with oxygen measurement designed to assess the intrusion of ambient air, with a 20 cm windbreak, there was a change of between 0,3 and 2,1% in the percentage of O₂ inside the chamber as the position of the fan varied. With a 35 cm windbreak, there was a change of between 0,2 and 0,5% in the percentage of O₂ inside the chamber as the position of the fan varied.

1. An open dynamic flux chamber (10) comprising:
a cylindrical box-like body having a bottom opening designed to be rested on an emitting surface; an inlet (15) for a vector gas, positioned on said box-like body; a hole (16) for taking measurements, positioned on said box-like body; and at least one vent hole (17) positioned on said box-like body to place the mixture of gas present in said box-like body in contact with the outside environment; characterized in that said flux chamber (10) has an flat upper base (11) and comprises a tubular shaped windbreak (40) positioned above said upper base (11) to protect said at least one vent hole (17) and having a length greater than 30 cm and a width greater than 5 cm.

2. A flux chamber (10) according to claim 1 characterized in that said flux chamber (10) comprises a spiral-shaped gas distribution system (30) inside said box-like body.

3. A flux chamber (10) according to claim 2 characterized in that said spiral-shaped, gas distribution system (30) comprises a tube (30) connected at one end to said inlet (15) for a vector gas and with the other end (32) closed, said tube (30) having a plurality of holes (35).

4. A flux chamber (10) according to claim 2 characterized in that said spiral-shaped gas distribution system (30) comprises a tube (30) positioned and fastened in a spiral inside said flux chamber (10).

5. A flux chamber (10) according to claim 1 characterized in that said flux chamber (10) has an upper base (11) removable from said flux chamber (10).

6. A flux chamber (10) according to claim 1 characterized in that airtight sealing is applied at the points of contact between said windbreak (40) and said flux chamber (10).

7. A flux chamber (10) according to claim 1 characterized in that said flux chamber (10) is made of polytetrafluoroethylene.

8. A flux chamber (10) according to claim 1 characterized in that said flux chamber (10) is made of an opaque material.

9. A method for measuring emissions of fumes emanating from a surface, by means of an open dynamic flux chamber (10), according to claim 1.

10. A method according to claim 9 characterized in that it comprises the step of applying a spiral-shaped tube (30) to the inside wall of said flux chamber (10) and applying a vector gas to said tube (30).
